(19) United States
(12) Patent Application Publication
(10) Pub. No.: US 2012/0040164 A1
(43) Pub. Date: Feb. 16, 2012

(54) LARGE-AREA PARTICLE-MONOLAYER AND METHOD FOR FABRICATING THE SAME

(75) Inventors: Wei-Li LEE, Taipei (TW); Chi-Chih Ho, Taipei (TW); Keng-Hui Lin, Taipei (TW); Wen-Tau Juan, Taipei (TW)

(73) Assignee: Academia Sinica, Taipei (TW)

(21) Appl. No.: 13/195,953

(22) Filed: Aug. 2, 2011

Related U.S. Application Data
(60) Provisional application No. 61/372,949, filed on Aug. 12, 2010.

(51) Int. Cl. C08L 25/06; B32B 27/36; B32B 27/32; C08L 71/02; B05D 1/18

(52) U.S. Cl. 428/220; 524/502; 427/430.1

(57) ABSTRACT

The present invention provides a particle monolayer and a method for fabricating the same. The method comprises the following steps: providing a container; adding a solvent into said container; adding a mixture of a particle-suspension and a spreading agent into said solvent; and adding a solvent-soluble polymer to said mixture to form a particle-monolayer. By using a solvent-soluble polymer, the particle monolayer fabricated by the method is a large-area particle monolayer with ordered structure, and the method can be used for any kind of substrates.

### BACKGROUND OF THE INVENTION

1. Field of the Invention

This invention is related to a particle-monolayer and method for fabricating the same; particularly, a large-area particle-monolayer and method for fabricating the same.

2. Description of the Related Art

Nanoscale physics has been found to be quite different from classical physics for decades. Since it ranges from few nanometers to hundreds of nanometers in length, most classical properties observed at macroscopic scale are changed while length scales downed. Thus, nano-sized particles, e.g. silicon, graphite and other metal materials, arranged in lattice or in network form can exhibit useful characteristics that are absent in their bulk form.

With the development of nanotechnology, there are several well-established nano-fabrication tools for fabricating nano-devices which are as small as few nanometers, such as a focused ion beam system (FIB), electro-beam lithography (EBL) and X-ray lithography (XRL). However, for fabricating large-area nano-lattice or ordered nano-pattern, FIB and EBL become impractical because of low throughput; and XRL, on the other hand, has high throughput but limited resolution due to a diffraction effect and a finite photo-electron energy range. Moreover, the above-mentioned tools require expensive investment on instrumentation and also costly subsequent maintenance.

In 1995, Hulteen and van Duyne pioneered nanoparticle lithography (NSL) to fabricate large area nanoparticle-monolayer by employing polystyrene nanoparticles, which are commercially available and uniformed in diameter (from about 10 nm to microns). Under appropriate conditions, the nanoparticles can self-assemble into a compact crystalline structure by spin coating or vertical pulling, and the compact crystalline structure can serve as a mask for thin film deposition or pattern etching. However, such techniques rely on interfacial properties which are substrate-dependent, and the close-packing domains of the nanoparticle-monolayers fabricated by NSL are usually of few μm² due to the instability during the solvent evaporation.

To sum up, there is a constant demand for a method to fabricate a large-area nanoparticle-monolayer, especially with highly ordered domains.

### SUMMARY OF THE INVENTION

In view of foregoing, one object of the present invention is to provide a particle-monolayer and method for fabricating the same, wherein the particle-monolayer fabricated is a large-area particle-monolayer and has large domains with highly ordered nano-structure.

Another object of the present invention is to provide a particle-monolayer and method for fabricating the same, wherein the particle-monolayer is robust and can be transferred to a substrate of any kind or with a surface of any curvature.

Another object of the present invention is to provide a particle-monolayer and method for fabricating the same, wherein the method has advantages of low-cost and high-throughput.

To achieve the above objects, the present invention provides a method for fabricating a particle-monolayer, comprising the following steps: providing a container; adding a solvent into said container; adding a mixture of a particle-suspension and a spreading agent into said solvent; and adding a solvent-soluble polymer to said mixture to form a particle-monolayer.

Preferably, said solvent is a water base.

Preferably, said solvent-soluble polymer has a molecular weight of 10,000˜10,000,000 g/mole.

Preferably, a concentration of said solvent-soluble polymer is no lower than 0.1 ppm; more preferably, said concentration of said solvent-soluble polymer is 0.1˜2000 ppm; even more preferably, 1˜500 ppm; most preferably, 1˜3 ppm.

Preferably, said solvent-soluble polymer comprises polyethylene oxide, polyvinyl alcohol, polyvinylpyrrolidone, poly-L-lysine or a combination thereof.

Preferably, said mixture comprises: 5˜67 wt % of said particle-suspension; and 23˜95 wt % of said spreading agent.

Preferably, said particle comprises a spherical particle, a rod-like particle, a disk-like particle, a polygonal particle or a combination thereof.

Preferably, a material of said particle is made of material which interacts with said solvent-soluble polymer by polymer bridging effect

Preferably, said material of said particle comprises polystyrene, PMMA, silica or a combination thereof.

Preferably, said spreading agent is a liquid with density lower than a density of said solvent; more preferably, said spreading agent comprises ethanol, methanol, isopropanol or a combination thereof.

Preferably, the method further comprises putting a confining mean in said container between steps of said providing a container and said adding a solvent into said container; wherein said confining mean is used for defining an area for adding said mixture.

Preferably, said confining mean is a Teflon ring.

Preferably, the method further comprises drawing the solvent after said particle-monolayer is formed and letting said particle-monolayer transfer onto the bottom of said container.

Preferably, said container further contains a substrate placed onto the bottom thereof.

Preferably, the method further comprises drawing the solvent after said particle-monolayer is formed and letting said particle-monolayer transfer onto said substrate.

Preferably, the method further comprises detecting a compacting structure of particles of said particle-suspension before adding a solvent-soluble polymer.

Preferably, said solvent-soluble polymer is not added until an area fraction (φ_{L}) of particles of said particle-suspension in said solvent is higher than 0.6.

The present invention also provides a particle-monolayer, comprising particles and a solvent-soluble polymer, said particles are densely packed with ordered structure, and said particle-monolayer has an area of more than 1 cm².

Preferably, said solvent-soluble polymer has molecular weight of 10,000˜10,000,000 g/mole.

Preferably, said solvent-soluble polymer comprises polyethylene oxide, polyvinyl alcohol, polyvinylpyrrolidone, poly-L-lysine or a combination thereof.

Preferably, a material of said particle is a material which interacts with said solvent-soluble polymer by polymer bridging effect

Preferably, said material of said particle comprises polystyrene, PMMA, silica or a combination thereof.

The present invention also provides a particle-monolayer, which is fabricated by said method.

To sum up, by adding a solvent-soluble polymer, particles of a particle-monolayer fabricated by the present invention can be closed packed with ordered structure; more specifically, with triangular lattice, and said particle-monolayer has an area of more than 1 cm²; in other words, said particle-monolayer has a large area and large close-packing domains. Furthermore, the method is suitable for forming a particle-monolayer on any kinds of substrates and has advantages of low-cost and high-throughput.

### BRIEF DESCRIPTION OF THE DRAWINGS

FIG. 1 shows diffraction patterns of particles (a) as φ_{L} is lower than 0.2; (b) as φ_{L} is between 0.5˜0.8; (c) as φ_{L} is higher than 0.8; (d) after the solvent-soluble polymer is added.

FIG. 2 shows the average Zeta potential exponentially decaying with the concentration of polyethylene oxide added.

FIG. 3 displays a flow chart of the method of the present invention.

FIG. 4 illustrates the particle-monolayers of (a) sample 1; and (b) sample 2; and shows the images as the particle-monolayer of sample 1 is transferred onto substrates with a free-standing surface (c); and a curved surface (d).

FIG. 5 displays a SEM image of the particle-monolayers of sample 2.

FIG. 6, displays optical microscope images of the particle-monolayers of (a) sample 2; (b) comparative sample 1; (c) is a 50× image of (a); and (d) is 50× image of (b).

FIG. 7 displays the data of monitoring Brownian motion of particles by continuously microscopic observation.

FIG. 8 displays a 473 nm laser scanning examination of a particle-monolayer of the present invention

### DETAILED DESCRIPTION OF THE PRESENT INVENTION

In the present invention, the traditional method for fabricating a particle-monolayer is improved by incorporating a solvent-soluble polymer. The technical feature results in the fabrication of a large-area particle-monolayer with ordered structure. In a prefer embodiment, the method of the present invention comprises the following parts:

Part I—a container is provided, a substrate is put onto the bottom of the container, and a solvent is added into said container.

The term “container” herewith is referred to as a container of any kind which is used for containing said solvent; wherein a shape, volume or bottom area thereof is not limited. Basically, the solvent can be any kind of liquids as long as the liquids do not influence other elements recited in the method of the present invention and has a density higher than a particle-suspension used hereinafter. Preferably, said solvent is a water base; wherein said water base is referred to as a water solution with any kind of solute, which does not influence the progresses of the method of the present invention. Specifically, water is the most preferable solvent as the advantages of availability and low-cost.

Said substrate can be composed of any kinds of materials, for example: a silicon substrate, a plastic object composed of Polyethylene terephthalate (PET), polycarbonate (PC) or polymethylmethacrylate (PMMA) or a transparent conductive plane composed of indium tin oxide (ITO), fluorine-doped tin oxide (FTO) or aluminum-doped Zinc Oxide (AZO). Moreover, the shape of said substrate or the surface of said substrate is not limited, for example, the surface of the substrate that contacts with the particle-monolayer of the present invention can be a flat surface, a curve surface, an irregular surface or a free-standing surface; wherein said free-standing surface is referred to as a surface with at least one hole thereon

Part II—a confining mean is put into the container, a mixture of a particle-suspension and a spreading agent is added at said solvent/air interface inside said confining mean.

The term “confining mean” herewith is referred to as a structure which can separate an area of the solvent/air interface from the others; in other words, said confining mean is used for defining an area of the solvent/air interface for adding said mixture. For instance, the confining mean can be a ring, a polygon structure or an irregular structure, which can float at the solvent/air interface, or a hollow pillar with a cross-section of round, polygon or irregular shape, which can stand at the bottom of said container and the top thereof is projected equal to or out of said solvent/air interface. Moreover, the confining mean can be composed of any kind of material as long as the material do not interact with other elements recited in the method of the present invention. Specifically, said confining mean is a Teflon ring.

The term “particle” herewith is referred as a spherical particle, a rod-like particle, a disk-like particle, a polygonal particle or a combination thereof in fine scale. Preferably, said particle is a nanoparticle, a microparticle or a combination thereof. More preferably, the extreme length of said particle is between 1 nm˜10 μm; more preferably, between, 100 nm˜1 μm. The materials of said particle are not limited. Any kinds of particles can be used as long as an appropriate solvent-soluble polymer is incorporated in accordance with the present invention. For example, the materials of said particle include, but not limited to polystyrene, polymethylmethacrylate (PMMA), silica or a combination thereof.

Furthermore, said particle is mixed with a spreading agent at a proper ratio. Said spreading agent is a liquid with density lower than a density of said solvent and can help said particle spread at the solvent/air interface. Said spreading agent includes, but not limited to methanol, ethanol, isopropanol or a combination thereof.

More specifically, an example of the mixture used in the present invention is prepared by centrifugating a commercial particle-suspension (Duke Scientific; 1 wt % or 10 wt %) to precipitate the particles therein; discarding the supernatant; adding ethanol and purified water (dd water); and resuspending the particles by a sonicator. Alternatively, the mixture used in the present invention is prepared by mixing a commercial particle-suspension (Duke Scientific; 10 wt %) with ethanol at a volume ratio of 1:1˜2:1.

Preferably, said solvent is stirred to help the spreading of the particle and the formation of the particle-monolayer of the present invention.

Part III—a packed structure of particles of said particle-suspension is detected.

A self-assembly of the particles is occurred during adding said mixture. Specifically, the self-assembly of particles can be detected by examining an area fraction (φ_{L}) of packing particles; that is, the φ_{L} can represent the packing structure of particles. Basically, the value of φ_{L} will increase while the volume of the particle-suspension added is increased. Moreover, as φ_{L} is lower than 0.2 (FIG. 1a), the particles are randomly distributed at the solvent/air interface; as φ_{L} is between 0.5˜0.8 (FIG. 1b), a diffraction pattern of the packing particles starts to show hexagonal symmetry with an inter-particle distance of about 500 nm estimated from the first-order and second-order peaks in the diffraction pattern; as φ_{L} is higher than 0.8 (FIG. 1c), the inter-particle distance is about 200 nm and will not be shorter even if the particle-suspension is continuously added. This may imply a coulomb repulsive force associated with the dipolar interaction arising from the induced charges on particles is occurred between the particles. Preferably, the solvent-soluble polymer is not added until an area fraction (φ_{L}) of particles of said particle-suspension in said solvent is higher than 0.6.

Part IV—a solvent-soluble polymer is added. Last, the solvent is drawn and the formed particle-monolayer is finally transferred onto said substrate.

The term “solvent-soluble polymer” herewith is referred to as any polymer with solvent-solubility. Preferably, said solvent-soluble polymer has a molecule weight of 10,000˜10,000,000 g/mole. Preferably, the concentration of said solvent-soluble polymer is no lower than 0.1 ppm; more preferably, said concentration of said solvent-soluble polymer is 0.1˜2000 ppm; even more preferably, 1˜500 ppm; most preferably, 1˜3 ppm. Preferably, the solvent-soluble polymer is selected in accordance with the particle used; for example, the solvent-soluble polymer includes, but not limited to polyethylene oxide, polyvinyl alcohol, polyvinylpyrrolidone, poly-L-lysine or a combination thereof. After the solvent-soluble polymer is added for few hours, a significant change in the diffraction pattern is observed (FIG. 1d); that is, only first-order peaks appear within the range. The observation agrees with the calculated diffraction pattern based on Ewald construction for close-packed particles with ordered structure. It hints that the solvent-soluble polymer is adsorbed onto the particles and results in at least two important consequences. First, the solvent-soluble polymer provides an effective screening of the coulomb repulsive force between the particles. Secondly, the solvent-soluble polymer triggers the polymer bridging effect that provides further bonding between the particles. Therefore, a close-packed particle-monolayer with triangular lattice structure is formed; more specific, the fabricated monolayer is of polymer/particles hybrid.

It is noted that the order of the aforementioned steps is not limited. For instance, the solvent-soluble polymer can be added with the mixture without detecting the structure of the particles in advance or before the mixture is added. In other words, as long as the solvent-soluble polymer can interact with the particles properly to provide the aforementioned effects during the self-assembly of the particles, the order of the aforementioned steps can be varied.

### Example 1

### Effect of a Solvent-Soluble Polymer

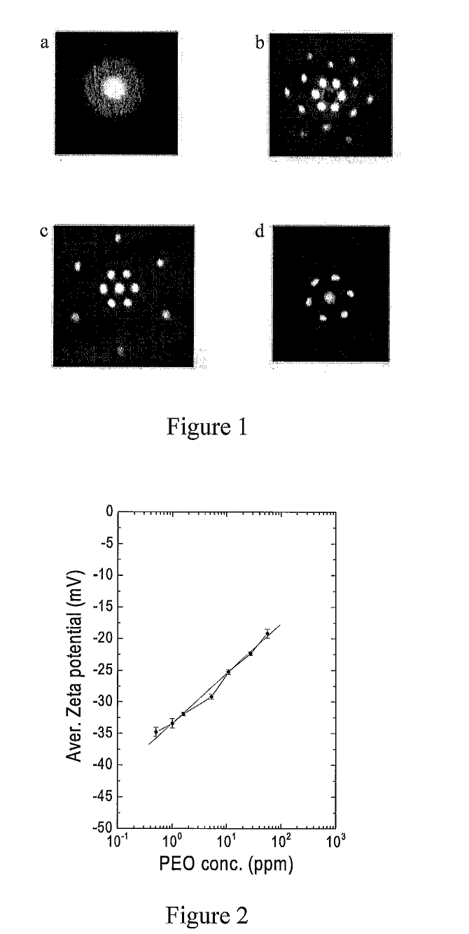

FIG. 2 shows how a solvent-soluble polymer is favorable for a close-packed particle-monolayer formation. As showed in FIG. 2, the average Zeta potential on the particles (polystyrene) logarithmically decayed with the concentration of a solvent-soluble polymer (polyethylene oxide, PEO) added, that is, from 0.5 ppm to 55 ppm. The data, which evidences our hypothesis before, suggests that the coulomb repulsive force between particles was sheltered and a polymer bridging effect was triggered for making the structure of the particle-monolayer much steadier.

### Example 2

### Fabrication for Particle-Monolayers

In this example, two samples of particle-monolayers (samples 1 and 2) in accordance with the present invention and one comparative particle-monolayer (comparative sample 1) by traditional method (without adding a solvent-soluble polymer) were prepared. Please refer to the following table 1 for details:

TABLE 1
samples 1, 2 and comparative sample 1

| | | | Comparative |
|---|---|---|---|
| sample | sample 1 | sample 2 | sample 1 |
| Particle | polystyrene | polystyrene | polystyrene |
| suspension | | | |
| Diameter of the | 1 μm | 220 nm | 220 nm |
| particle | | | |
| Spreading | ethanol | ethanol | ethanol |
| agent | | | |
| Solvent-soluble | polyethylene | polyethylene | None |
| polymer | oxide | oxide | |
| Concentration | 3 ppm | 3 ppm | None |
| of the polymer | | | |
| Molecular | 1,435,000 | 1,435,000 | None |
| weight of the | | | |
| polymer | | | |
| Solvent | deionized water | deionized water | deionized water |
| Confining | Teflon ring | Teflon ring | Teflon ring |
| mean | | | |
| Substrate | silicon substrate | silicon substrate | silicon substrate |
| (2 cm × 2 cm) | | | |

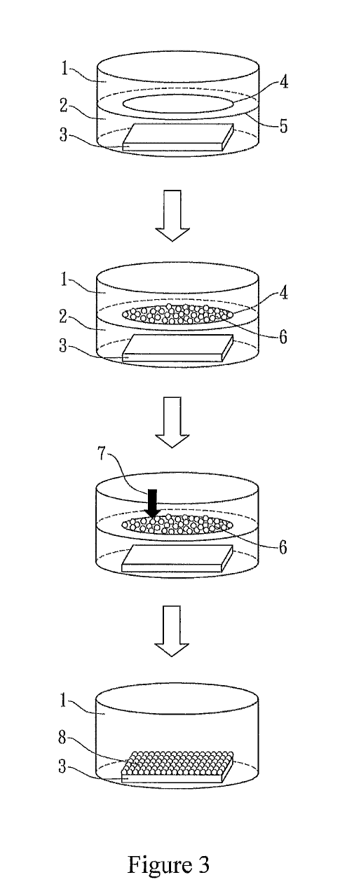

The preparation of samples 1 and 2 was according to the method of the present invention. Briefly, please see FIG. 3, first, a container 1 containing deionized water 2 was prepared. A silicon substrate 3 and a Teflon ring 4 were placed inside the container 1. As noted, said Teflon ring 4 floated at the water/air interface 5. Then, a particle suspension of polystyrene was mixed with ethanol of equal volume, which was served as a spreading agent. The mixture of said particle suspension (particles 6) and ethanol (not shown) was then added inside the Teflon ring 4 at the water/air interface 5. The mixture was continuously added until the φ_{L} of particles is over 0.8 (please refer to FIG. 1c).

Next, polyethylene oxide (a solvent-soluble polymer 7) was added into the mixture, and the interaction between particle 6 and polyethylene oxide was conducted.

After few hours, a particle-monolayer 8 (a monolayer of polymer/particles hybrid) was formed, and the deionized water 2 was drawn slowly until the formed particle-monolayer 8 was transfer onto said silicon substrate 3 (after the particle-monolayer 8 was transfer onto said silicon substrate 3, the Teflon ring 4 was removed as showed in FIG. 3).

Accordingly, samples 1 and 2 were prepared by the same method in accordance with the present invention but different in the diameter of the particle used and the weight percentage of particle suspension in the mixture (sample 1: 20 wt %; sample 2: 10 wt %). Comparative sample 1 was prepared by traditional method; that is, the preparation were the same as the method above without adding the solvent-soluble polymer (in comparative sample 1, the weight percentage of particle suspension in the mixture is 10 wt %).

### Example 3

### Examinations for Samples 1, 2 and Comparative Sample 1

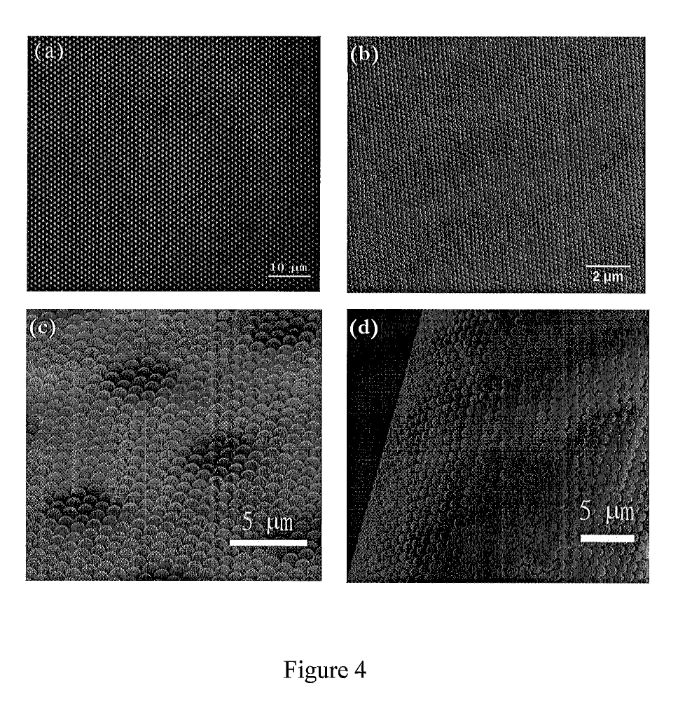

FIGS. 4a and 4b show the images of samples 1 and 2, respectively; wherein the surfaces of the substrates used in FIGS. 4a and 4b are flat surfaces. The defect-free region is more than 100 μm×100 μm for sample 1 and more than 20 μm×20 μm for sample 2. In other words, both samples 1 and 2 have large close-packing domains. It is noted that the entire substrate area larger than 1 cm² is uniformly covered by the particle-monolayer (not shown), and the particles are in contact with each other without major cracks or vacancies (FIGS. 4a and 4b). Also, please refer to FIGS. 4c and 4d, wherein the particle-monolayer of sample 1 is transferred onto substrates with a free-standing surface and a curved surface, respectively. The darker regimes of the particle-monolayer showed in FIG. 4c represents that the substrate under those regimes is a hole array, therefore, the particles among those regimes are freely standing (without any support from the substrate) by assistance of the bonding force between adjacent particles. According to FIG. 4d, it is obviously that the particle-monolayer of sample 1 maintains compact and close-packing structure even if being transferred onto a curved surface. Based on the images above, it is proved that a strong interaction exists between the particles in the particle-monolayer made by the method of the present invention.

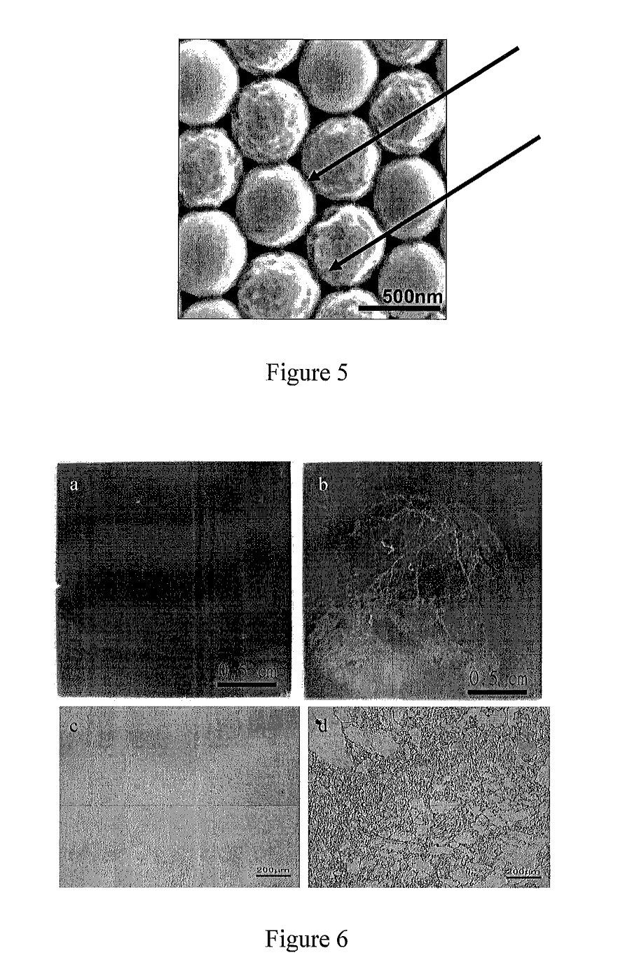

Then, please refer to FIG. 5, the SEM image shows that in the packed structure of the particle-monolayer of sample 2, the polyethylene oxide (solvent-soluble polymer) is coated on the surface of and between the particles (the arrowed sites in FIG. 5). This data supports that a bridging effect is provided by the polyethylene oxide (solvent-soluble polymer) for enhancing the bonding between the particles.

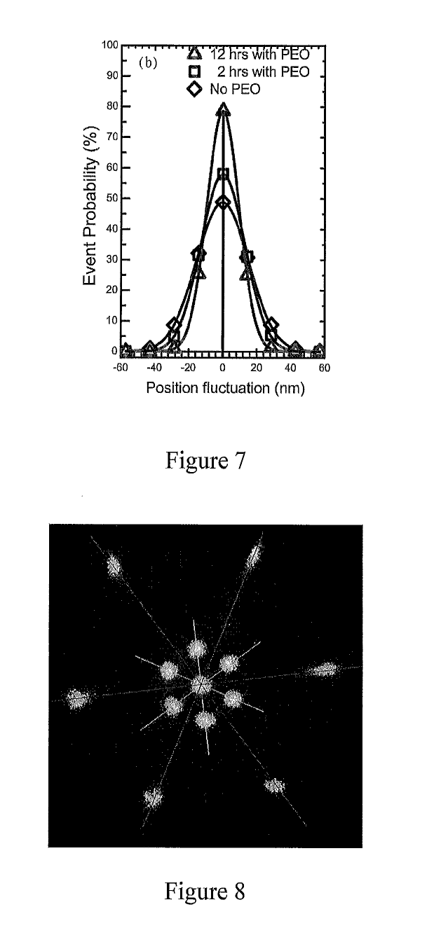

Furthermore, please refer to FIGS. 6a and 6b, which are optical microscope images for comparison of sample 2 and comparative sample 1, respectively. As show in FIG. 6a, the particle-monolayer of sample 2 is transparent due to the close-packed structure thereof; whereas, in FIG. 6b, the particle-monolayer of comparative sample 1 is blurred and non-transparent with lots of cracks. The difference is much more clear while the images are magnified for 50× (FIGS. 5c and 5d, respectively). Also, we monitored the Brownian motion of the particles of the particle-monolayer of sample 1. The result is shown in FIG. 7. As noted, the particle-monolayer made by PEO has a higher and narrower peak representing less Brownian motion between particles resulting from stronger interaction thereof. In other words, the bridging effect provided by the solvent-soluble polymer (PEO) is so strong that the motion of the particles is limited.

Last, a particle-monolayer of the present invention is examined by 473 nm laser scanning. The result of laser scanning showed a highly symmetric diffraction pattern (FIG. 8), which meant the structure of said particle-monolayer is in an ordered structure; more specifically, in a triangular lattice. Also, the diameters of the laser beams are all 3 mm, which meant an uniform structure of said particle-monolayer.

For experimental purpose, different PEO concentration of 500 ppm or even up to 2000 ppm is used for the formation of the particle-monolayer of the present invention. It is noted that the bonding strength between particles can be greatly improved by introducing more PEOs (data not shown). The aforementioned preferable range of the concentration of the solvent-soluble polymer is picked based upon both the desired effects of adding the solvent-soluble polymer and economic consideration. In other words, if stronger bonding force is required, one may introduce more solvent-soluble polymer of the present invention. Whereas, 1-3 ppm of solvent-soluble polymer is sufficient to provide enough bonding force for most circumstance under economic consideration.

In addition, we also used PEO with different molecular weight of 723,500 and 116,300 g/mole. The results were well-reproduced and consistent with the aforementioned embodiments (date not shown).

The embodiments and the technical principles used are described above. All variations and modifications of the present invention and the uses thereof are included in the scope of the present invention if they do not depart from the spirit of the disclosure of this specification and drawings.

What is claimed is:

1. A method for fabricating a particle-monolayer, comprising the following steps:
providing a container;
adding a solvent into said container;
adding a mixture of a particle-suspension and a spreading agent into said solvent; and
adding a solvent-soluble polymer to said mixture to form a particle-monolayer.

2. The method according to claim 1, wherein said solvent is a water base.

3. The method according to claim 1, wherein said solvent-soluble polymer has a molecular weight of 10,000˜10,000,000 g/mole.

4. The method according to claim 1, wherein a concentration of said solvent-soluble polymer is no lower than 0.1 ppm.

5. The method according to claim 1, wherein said solvent-soluble polymer comprises polyethylene oxide, polyvinyl alcohol, polyvinylpyrrolidone, poly-L-lysine or a combination thereof.

6. The method according to claim 1, wherein said mixture comprises:
5˜67 wt % of said particle-suspension; and
23˜95 wt % of said spreading agent.

7. The method according to claim 1, wherein said particle comprises a spherical particle, a rod-like particle, a disk-like particle, a polygonal particle or a combination thereof.

8. The method according to claim 1, wherein a material of said particle is a material which interacts with said solvent-soluble polymer by polymer bridging effect.

9. The method according to claim 8, wherein said material of said particle comprises polystyrene, PMMA, silica or a combination thereof.

10. The method according to claim 1, wherein said spreading agent is a liquid with density lower than that of said solvent.

11. The method according to claim 1, further comprising putting a confining mean in said container between said providing a container and said adding a solvent into said container; wherein said confining mean is used for defining an area for adding said mixture.

12. The method according to claim 1, further comprising drawing the solvent after said particle-monolayer is formed and letting said particle-monolayer transfer onto the bottom of said container.

13. The method according to claim 1, wherein said container further contains a substrate placed onto the bottom thereof.

14. The method according to claim 13, further comprising drawing the solvent after said particle-monolayer is formed and letting said particle-monolayer transfer onto said substrate.

15. The method according to claim 1, further comprising detecting a compacting structure of particles of said particle-suspension before adding a solvent-soluble polymer.

16. The method according to claim 1, wherein said solvent-soluble polymer is not added until an area fraction (φ_{L}) of particles of said particle-suspension in said solvent is higher than 0.6.

17. A particle-monolayer, comprising particles and a solvent-soluble polymer, wherein said particles are densely packed with ordered structure, and said particle-monolayer has an area of more than 1 cm².

18. The particle-monolayer according to claim 17, wherein said particles are densely packed with triangular lattice.

19. The particle-monolayer according to claim 17, wherein said solvent-soluble polymer has molecular weight of 10,000˜10,000,000 g/mole.

20. The particle-monolayer according to claim 17, wherein said solvent-soluble polymer comprises polyethylene oxide, polyvinyl alcohol, polyvinylpyrrolidone, poly-L-lysine or a combination thereof.

21. The particle-monolayer according to claim 17, wherein a material of said particle is a material which interacts with said solvent-soluble polymer by polymer bridging effect.

22. The particle-monolayer according to claim 17, wherein said material of said particle comprises polystyrene, PMMA, silica or a combination thereof.

23. A particle-monolayer, which is fabricated by the method according to claim 1.
